(19) United States
(12) Patent Application Publication
(10) Pub. No.: US 2007/0226047 A1
(43) Pub. Date: Sep. 27, 2007

(54) Method and Process for Capturing, Storing, Processing and Displaying Customer Satisfaction Information

(76) Inventor: Andrew David Ward, Piscataway, NJ (US)

Correspondence Address: WHITE-WELKER & WELKER, LLC, P.O. BOX 199, CLEAR SPRING, MD, 21722-0199, US

(21) Appl. No.: 11/737,242

(22) Filed: Apr. 19, 2007

Related U.S. Application Data
(63) Continuation of application No. 10/346,797, filed on Jan. 18, 2003.

(51) Int. Cl. G06Q 90/00

(52) U.S. Cl. 705/10

(57) ABSTRACT

A process and method for collecting, validating, storing, scoring and presenting consumer satisfaction feedback on the delivery of goods and services sold to consumers by service providers. The feedback of consumers is collected by using electronic forms to capture consumer responses to questions on surveys. Consumer feedback is scored over at least three recent periods of time including the past twelve months, the past six months and past three months. The customer satisfaction scores are presented on a plurality of advertising medias.

### CROSS REFERENCE TO RELATED APPLICATIONS

This application is an continuation of U.S. patent application Ser. No. 10/346,797, entitled “Method and process for Capturing, Storing, Processing and Displaying Customer Satisfaction Information”, filed on Jan. 18, 2003, which is incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to method for tracking advertising. More specifically the present invention relates to a process and method that enables service companies such as physicians and tradesman a method to collect, store and score the satisfaction level of their customers and present said score on multiple forms of advertising.

### BACKGROUND OF THE INVENTION

Attracting new customers is the biggest challenge for most small business owners according to annual surveys. Advertising is commonly used by many businesses to build awareness of their services and to attract customers who are in need of the service that they provide. However, advertising for small businesses is very expensive. It is expensive because of its inherent inefficiencies. This problem is particularly acute for small service companies who provide services to consumers. Advertisements also serve an important role in providing consumers with information that they rely on to make their purchase decisions.

The inefficiency of advertising stems from the inability to target potential customers accurately. For example, a dentist who needs more patients has no way of knowing who needs dental services within his or her service area. Therefore, the dentist places ads that target people within a general geographic area. The majority of people that are reached by the advertisement will not need this dentist services for one of several reasons. They either have no current need for dental services or they already have a dentist that they use and our satisfied with. As a result nearly 100% of the advertisement is wasted. A highly targeted direct mail advertisement that delivers two or three percent response rate is considered very successful.

Another goal of advertising is to build awareness. The benefit of awareness is that consumers will often choose service providers based on familiarity gained from repeated exposure to a given service provider's advertisement. Many studies on advertising effectiveness say that it takes six or more exposures to a given advertisement for it to register with a consumer. But this is often financially impractical for most small service companies. This results from the difficulty in asking people to think about problems before they experience them. Most people chose not to dwell on problems they don't have and simply ignore the advertisement. Therefore is it hard for the ad for such a service to capture the awareness of consumers prior to having a need. As a result of these inefficiencies, advertising benefits the largest companies whose revenues can support a high level of sustained advertising.

Specific forms of advertising were crated to address this inequity, namely printed phone books with yellow page sections that list businesses. Phone books list most businesses organized by geography, type of service provide and alphabetically. Consumers regularly consult such phone directories to find potential service providers when they have a need because it is often the only source of such information. Again, larger companies can dominate their respective classification by purchasing large display ads. Display ads are positioned in the front of each service grouping with the largest ads getting preferential treatment. Studies show that the majority of consumers respond to the bigger ads. As a result most businesses listed in phone directories decide against buying display ads because they cannot afford to compete with larger companies.

Another form of advertising specifically created to address small service companies are referral services also known as matching services. Referral services charges fees to participating service companies for providing leads. Often companies are screened as a condition of participation. By screening companies or conducting a background check referral companies can eliminate those service providers who have poor credit, legal or known customer satisfaction problems.

There are several problems with referral services that are a concerned to consumers. First they require consumers to provide detailed information on the work that they need completed. Many consumers don't like to give personal information to strangers and find this unacceptable. The consumer-information is matched against a list of service providers who are in the area and can provide the required service. Normally three to five service providers are sent the lead. Each service provider is responsible for contacting the prospective customer and selling their services. In this model the consumer has no input on the service providers being selected for them.

Consumers like to make informed purchasing decisions that they can have confidence in. They regularly seek out trusted third party information prior to making purchasing decisions. In recognition of this need, virtually every product and service whose attributes and performance can be measured objectively is routinely evaluated by magazines, newspapers, and consumer organizations. There are several companies that have been created specifically to providing consumers with objective evaluations of manufactured goods and services covering, automobiles, consumer electronics, colleges, financial instruments airlines just to name a few.

Traditional methods of evaluating goods and services are effective for goods that are produced in large volumes. They also are effective in comparing services of companies that have very large customer bases.

Mass produced consumers goods are manufactured to exacting quality control standards. This produces products with identical performance and quality. The results obtained by testing a single unit will be indicative to what most consumers will experience when purchasing the same model and make of product regardless of where or who the product is purchased from.

Large service organization such as commercial airlines use uniform processes designed to deliver consistent levels of service for their customers. By surveying statistically significant numbers of customers an accurate evaluation can be made.

But it is impractical to employ traditional evaluation techniques to small companies for several reasons. The first is cost. It would simply be cost prohibitive for small companies to evaluate their customers. Secondly the service delivered by small companies can vary greatly from customer to customer.

As a result consumers often have little or no objective information by which to evaluate competing service companies. This is precisely the reason that references are so important when evaluating service companies, because no other information exists. This lack of information results in high levels of customer dissatisfaction. The problem is so bad in certain industries such as home improvements, that consumers expect that they will experience some level of dissatisfaction.

In the absence of any objective measure of their work combined with intense competition many service providers set unrealistic expectations to gain the customer's business. Commissioned sales people often misrepresent their firm's abilities in order to make their sales quota. Services providers quote a low price to close the business and then add additional charges to the job or sometimes simply fail to complete the work. Some service providers will use inferior materials to keep cost down producing work that will ultimately lead to customer dissatisfaction. To compensate for the low quoted cost they often charge additional costs throughout the project or sometimes they fail to complete the job because they are losing money. For these reasons and more, consumers experience a great deal of dissatisfaction when using service providers.

It is thus seen that a need exists that enables service providers to cost effectively advertise their services based on their ability to satisfy their customers and to provide consumers with information that they can trust to make educated decisions when choosing a service provider.

### SUMMARY OF THE INVENTION

The present invention relates to a process and method that enables service companies such as physicians and tradesman a method to collect, store and score the satisfaction level of their customers and present said score on multiple forms of advertising. The process includes using a neutral party that verifies transactions between service providers and their customers by the use of Transactions Identifiers (TI). The neutral party creates uniquely coded TIs for each service provider. Service providers give one TI to each customer at the time of sale. Consumers possessing a TI can log onto the neutral party's web site after the service was provided, complete a survey that captures their satisfaction with the service that was provided to them. The neutral party processes the customer feedback for each service provider and creates a score. This score is presented on the neutral party's web site and can be presented or reference by multiple advertising medias. This process and method enables service prodders to attract customers by the level of customer satisfaction that they generate and it affords consumers an objective way of qualifying the services of service providers.

Accordingly, besides the objects and advantages of collecting, storing and scoring customer satisfaction data for service companies, several objects and advantages of the present invention are:

It is one objective to provide a system and method for a service company to objectively differentiate the value of their services as measured by the satisfaction of their customers.

It is another objective to provide a method and systems for advertisers to improve their advertising effectiveness by including customer satisfaction information within a plurality of advertising medias.

It is still another objective to provide a method and process for advertisers to include trusted third party satisfaction information in a plurality of advertising types.

Another objective is to provide a system and method for maintaining the integrity of customer satisfaction information collection, storage, processing and displaying process.

Yet another objective is to provide a system and method for potential consumers to evaluate advertisers base on historical customer satisfaction information prior to making a purchase.

Another objective is to provide an incentive for advertisers to continually improve the quality of their services and service delivery.

Yet another objective is to provide a system and method for creating physical Transaction Identifiers which are to be given to customers at the time of purchase.

It is still another objective to provide a system and method to insure that a transaction occurred between an advertiser and a customer wherein Transaction Identifiers are generated for debit card and credit card companies and to provide a system and method for consumers to register with trusted third party.

It is still another objective to provide a system and method for consumers to complete customer satisfaction surveys for a plurality of business types using a plurality of customer satisfaction surveys; to provide a system and method for serving a plurality of specific customer satisfaction surveys; to provide a system and method for creating a plurality of customer satisfaction surveys for a plurality of industry categories; and to provide incentives for consumers to complete their customer satisfaction surveys.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow diagram of the present process and method for the collecting, processing, scoring and presentation of customer satisfaction information;

FIG. 2 is a flow diagram illustrating the operations of a consumer completing a customer satisfaction survey;

FIG. 3 is a flow diagram illustrating the creation of TIs for advertisers;

FIG. 4 is a flow diagram illustrating creation of a digital TI.;

FIG. 5 illustrates a Customer Satisfaction Score;

FIG. 5A illustrates the web presentation of advertiser's Customer Satisfaction Score on TRUSTED THIRD PARTY's web site;

FIG. 6 illustrates a physical Transaction Identifier;

FIG. 7 illustrates a sample Customer Satisfaction Survey;

FIG. 8 illustrates the database fields in the Advertiser table;

FIG. 9 illustrates the database fields in the Registered Consumer table;

FIG. 10 illustrates the database fields in the Customer Satisfaction Survey results table;

FIG. 11 illustrates the database fields in the Issued Transaction Identifier table;

FIG. 12 illustrates the database fields in the Survey table; and

FIG. 13 illustrates a flow diagram illustrating the computation of a Customer Satisfaction Score for an Advertiser.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the method and system of the present invention.

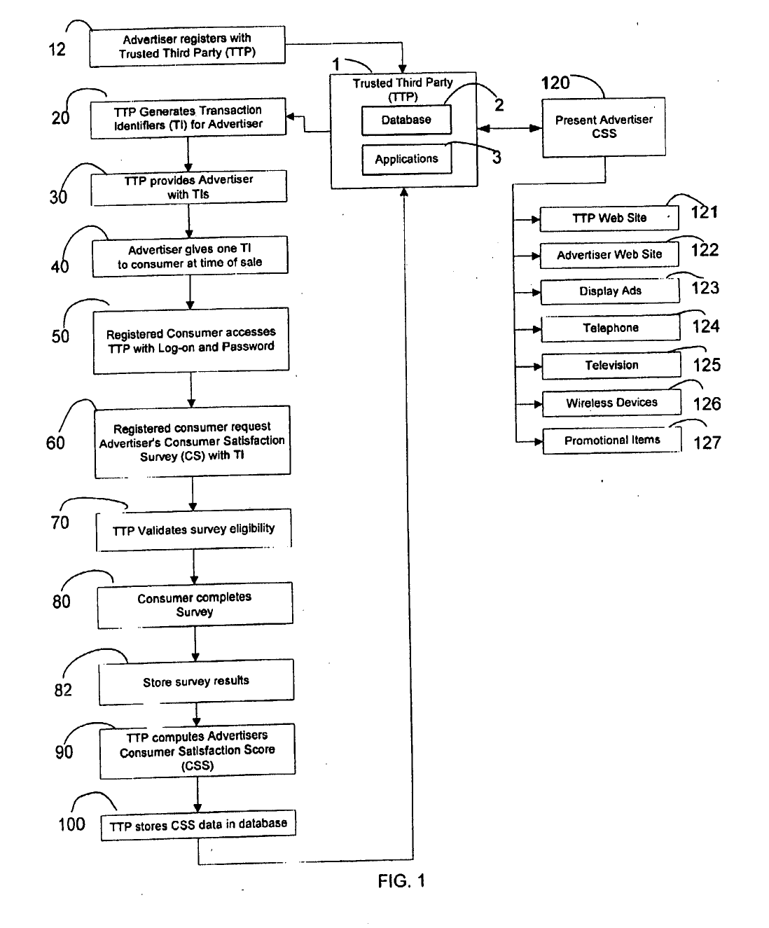

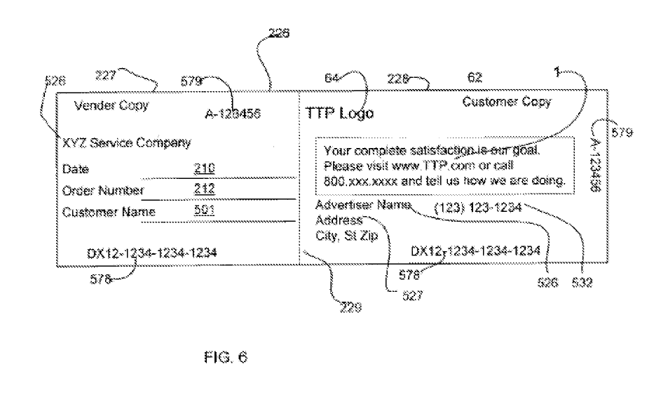

An embodiment of the method and system of the present invention will now be discussed with reference to FIGS. 1-11. FIG. 1 illustrates the information flow between relevant parties according to one embodiment of the present invention. As shown, a business that chooses to Advertiser with the Trusted Third Party (TRUSTED THIRD PARTY) 1 registers 12 with Trusted Third Party (TRUSTED THIRD PARTY). Registration data of said advertiser is stored in database 2 of TRUSTED THIRD PARTY 110 in Advertiser Table 525. TRUSTED THIRD PARTY generates a series of unique Transaction Identifiers (TIs) (FIG. 6) for said Advertiser 20. A digital record of the TIs generated for said Advertiser is stored in TI Table 575 within the TRUSTED THIRD PARTY's database 2. Physical TIs (FIG. 6) are given 30 to said Advertiser. Said Advertiser gives one TI to each of their customers at the time said customer purchases services or merchandise from said advertiser 40.

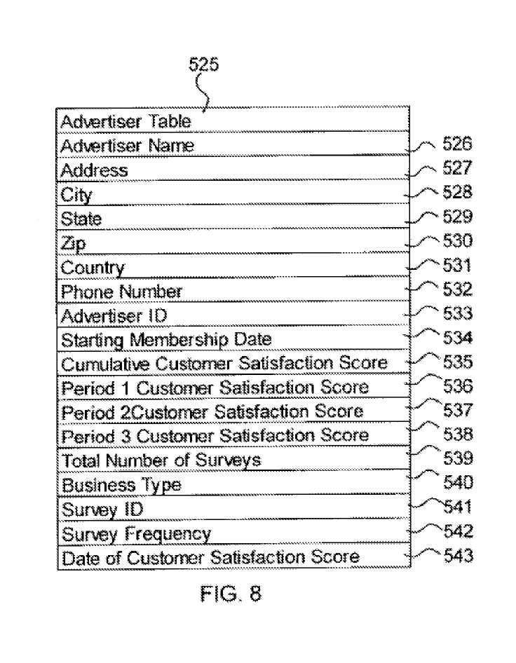

In the preferred embodiment, customer of said Advertiser who is registered with TRUSTED THIRD PARTY accesses TRUSTED THIRD PARTY's application 3 from any device that has access to the Internet with browser such as Microsoft Internet Explorer.RTM. or Netscape Navigator.RTM. Customer is authenticated to TRUSTED THIRD PARTY by entering their unique logon and password information 50. Said customer request a Consumer Satisfaction Survey (CSS) from TRUSTED THIRD PARTY Consumer Survey process 60 by entering advertisers phone number (FIG. 6) 532 and the TI code (FIG. 6) 578 that is printed on the TI in their possession. TRUSTED THIRD PARTY validates eligibility of consumers request 70 and returns a specific online survey as defined in Advertiser Table (FIG. 8) 525 Survey ID field 514.

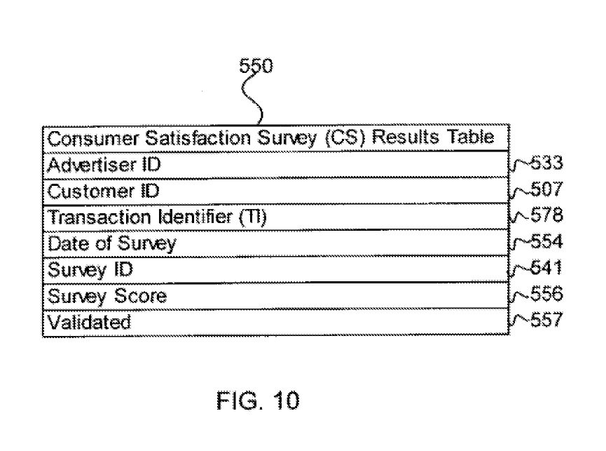

Said consumer answers CSS questions by selecting a single answer from a range of possible responses for each question on the CSS 80. The results of the completed CSS are stored 82 in CSS Results Table (FIG. 10). TRUSTED THIRD PARTY computes (computation fig show process) updated Consumer Satisfaction Score (CS Score) 90 for said Advertiser and stores 100 new CS Score in Advertiser Database table (FIG. 8) for said Advertiser.

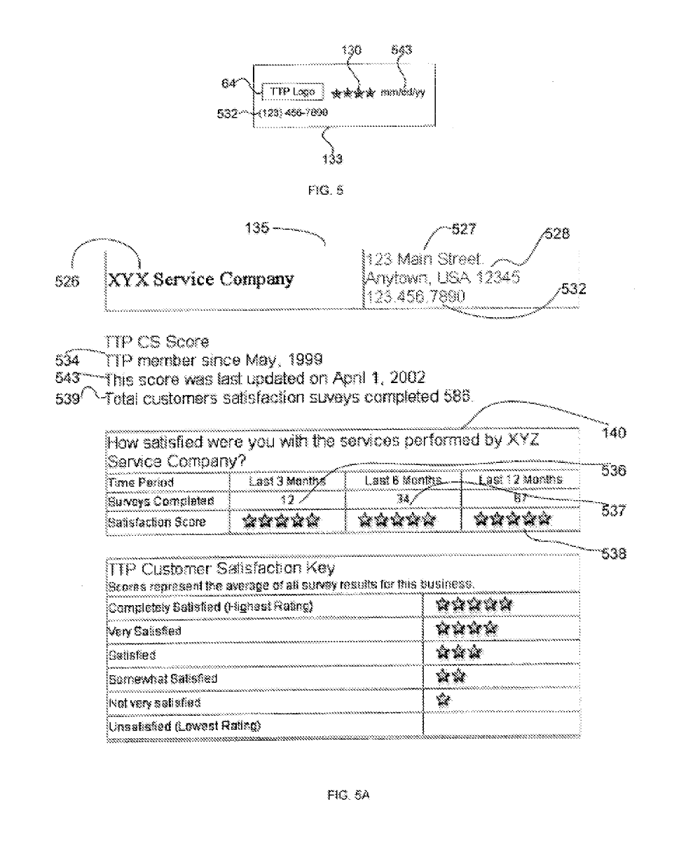

TRUSTED THIRD PARTY makes CS Scores of Advertisers available for presentation 120 in the following advertising media, TRUSTED THIRD PARTY Web Site 121 (FIG. 5) 135, Advertisers Web Site 122, Display Advertisements 123, Telephone 124, Television 125, Wireless Devices 126 and Promotional Items 127.

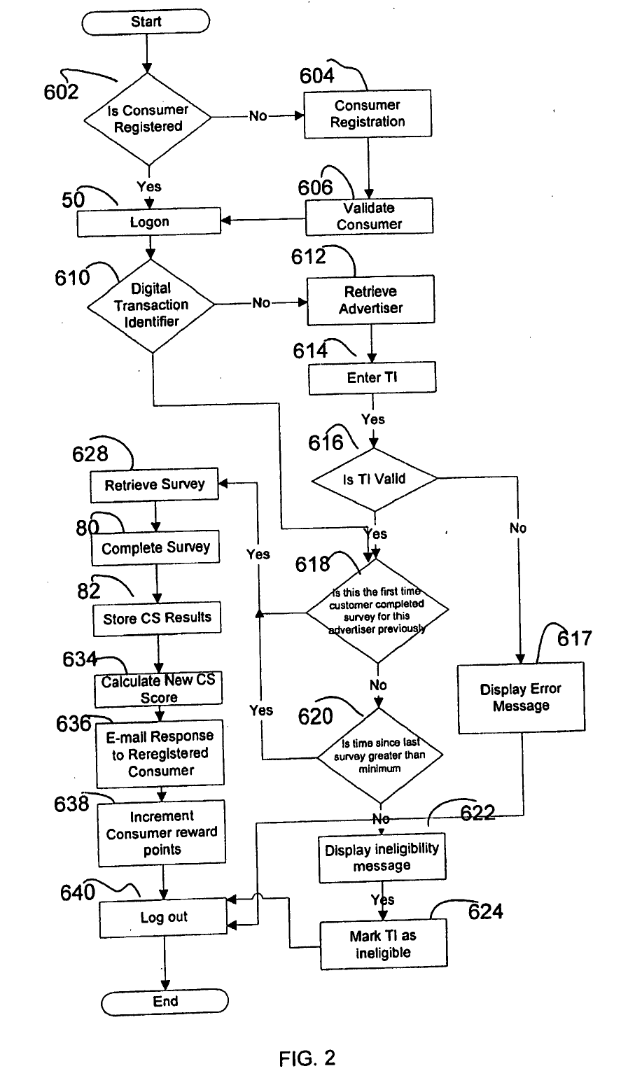

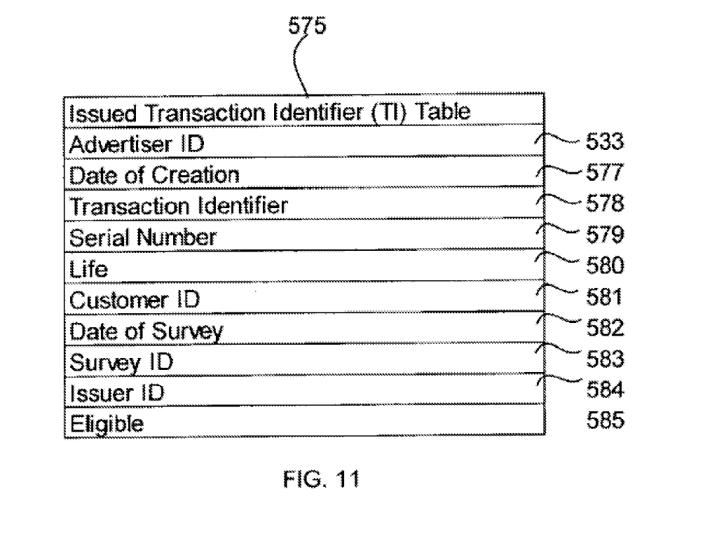

Referring now to FIG. 2, the secure consumer survey process is illustrated. Upon entering the TRUSTED THIRD PARTY 1 Internet site new consumers can register with TRUSTED THIRD PARTY 604. After registration TRUSTED THIRD PARTY will validate consumer data 606 to assure that consumer is real and their entry is unique. Registered consumers can log onto TRUSTED THIRD PARTY site 50. Consumers can retrieve a survey if they have Digital TI in their account 610 or they can retrieve a survey manually by retrieving the advertiser 612 and entering the TI code that is on their TI 614. An integrity check is complete to insure that a valid request is being made. First the TI code enter by consumers are matched 616 against TI codes in the Issued TI Table (FIG. 11) 575. A check will be made for a record with a matching Advertiser ID (FIG. 11) 533, a matching Transaction Identifier code (FIG. 11) 578 and a null entry in the Customer ID (FIG. 11) 507. If no match is found the customer will be presented with an error message 617. A second test is completed to see if said consumer has completed a survey for this advertiser previously by searching the Customer Satisfaction Survey Results Table (FIG. 10) 550. A search will look for a record where a match exists for Customer ID (FIG. 10) 507 and Advertiser ID 533. If a matching record exist a final test compare the time since the last survey was completed and the minimum time specified in the Advertiser Table (FIG. 8) 525 Survey Frequency field 542. If sufficient time hasn't past since the last survey was complete the customer will be presented with an ineligible message 622 and the TI will be marked as ineligible 624 by placing x in the Eligible field (FIG. 11) 585.

Eligible surveys are retrieved 628 and completed by customer 80. The survey results are stored 82 in TRUSTED THIRD PARTY's database. A new Customer Satisfaction score for this Advertiser is computed 634. Said consumer is awarded points for completing said survey 636. The results of the survey are emailed to said consumer 636. Said consumer logs off TRUSTED THIRD PARTY web site 640.

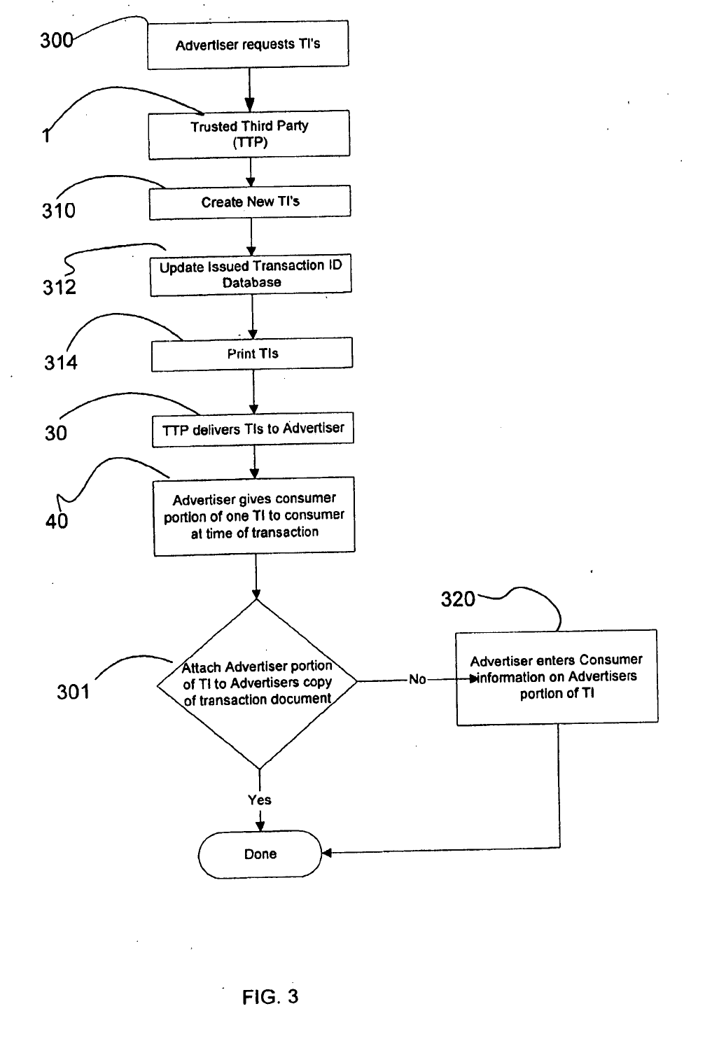

Referring now to FIG. 3, we describe the process of creating unique Transaction Identifiers for registered Advertisers and distributing TI's to advertiser's customers. 300 register Advertisers request TI's from TRUSTED THIRD PARTY 1. TRUSTED THIRD PARTY 1 creates unique TI codes 310 and stores TI codes in Issued Transaction ID Table (FIG. 11) 575. Physical TI's (FIG. 6) 226 are printed by TRUSTED THIRD PARTY 1 and delivered to said Advertiser 30.

Advertiser 300 gives the consumer portion (FIG. 6) 228 of one TI to each customer at time of purchase 40 of goods or services by customer from Advertiser. Advertiser 300 records consumer data on advertiser's portion of said TI (FIG. 6) 227.

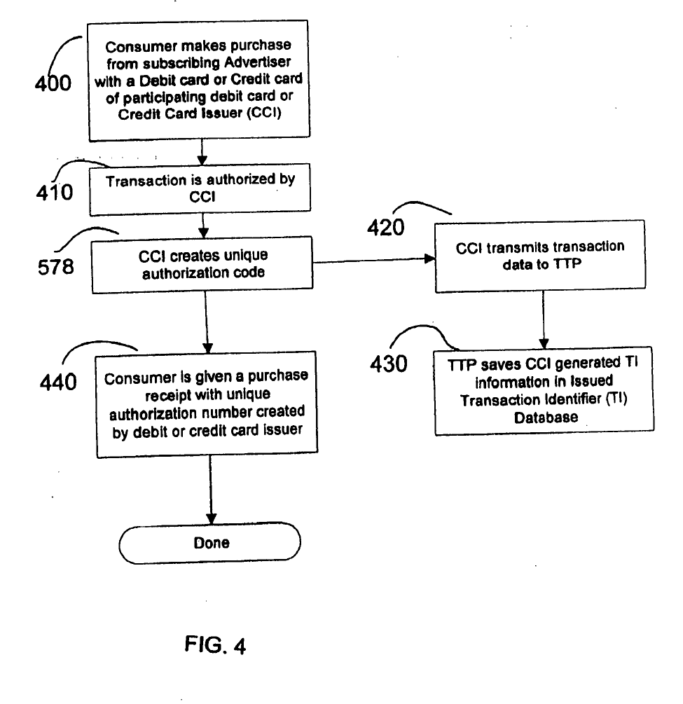

Referring now to FIG. 4, we illustrate the creation of a digital TI when consumer uses a credit card or debit card to buy goods and service from advertiser. Consumer pays 400 for purchases goods and services with a credit card or debit card of a participating Credit Card Issuer (CCI). The transaction is authorized by CCI 410 and a unique transaction code is created and issued by CCI 578. CCI transmits transaction 420 data consisting of Advertiser identification, customer identification and transaction code to TRUSTED THIRD PARTY. TRUSTED THIRD PARTY saves CCI transaction 430 data to Issued Transaction Identifier (TI) Table (FIG. 11) 575 using the CCI transaction code as the TI. Consumer is given CCI authorized purchase receipt 440 with CCI's transaction code.

Referring now to FIG. 5, we illustrate the components of TRUSTED THIRD PARTY created mark that Advertiser can display on a plurality of advertising medias. The key components of said mark include the logo of TRUSTED THIRD PARTY 64, said advertisers Customer Satisfaction Score 130, the date that said Customer Satisfaction Score was computed by TRUSTED THIRD PARTY 543 and a means of identifying said Advertiser 532.

Referring now to FIG. 5A we illustrate the components of TRUSTED THIRD PARTY created web page 136 presenting Registered Advertiser's customer satisfaction history and score. The key data to be displayed are, said Advertisers Name 526, date of said Advertisers original membership 543, the number of Customer Satisfaction Surveys completed to date 539, the question or questions asked on survey 140, and the number of surveys and their average score for the last year 536, the last 6 months and the last 3 months 538.

Now referring to FIG. 6 we illustrate the preferred embodiment of a physical Transaction Identifier (TI) 226. Each TI consists of two parts, the Advertisers section 227 and the customer's section 228. The TI can be printed on a plurality of substrates. The consumer's portion can be detached from the Advertisers section by tearing a perforation 229. The key data on the preferred embodiment of the TI's are a serial number 226, said advertisers name 526, said Advertiser address 527, said Advertisers phone number 532, TRUSTED THIRD PARTY's web site URL, TRUSTED THIRD PARTY's phone number, TRUSTED THIRD PARTY logo 64 and TI code which consist of a randomly generated alpha numeric code 578. Said Advertiser's section contains sections for collecting consumer information 501, order number 212 and date of transactions.

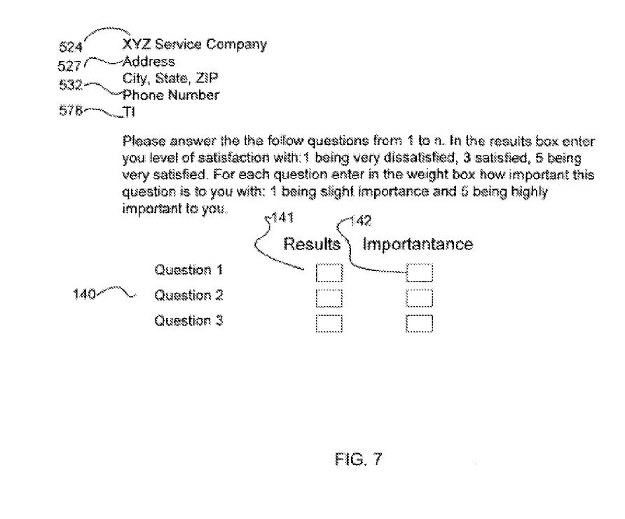

Now referring to FIG. 7 we illustrate the preferred embodiment of a Customer Satisfaction Survey. TRUSTED THIRD PARTY maintains a plurality of surveys that are served to consumers based upon the contents of the Survey ID field (FIG. 8) 541. The data on each survey contains Advertisers name 524, Advertisers address 527, Advertisers phone number 532, Transaction Identifier Code 578, a means for displaying a plurality of questions 140, a means for collecting consumer responses, and said customers weighting of the importance of each question being asked 142. The preferred embodiment of said survey is presented to said customer via a web page. Additional embodiments would capture the same information via the telephone.

Now referring to FIG. 8 we show the fields of information that TRUSTED THIRD PARTY maintains for each registered advertiser in the Advertiser Table 525.

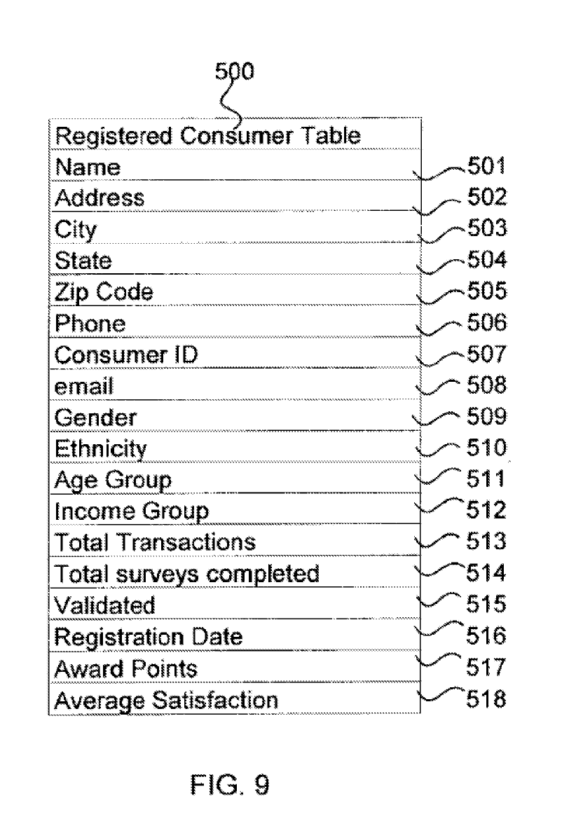

Now referring to FIG. 9 we show the field of information that TRUSTED THIRD PARTY maintains for each registered consumer on TRUSTED THIRD PARTY.

Now referring to FIG. 10 we show the fields of information that TRUSTED THIRD PARTY maintains for collecting the results of each Customer Satisfaction Survey Completed.

Now referring to FIG. 11 we show the fields of information that TRUSTED THIRD PARTY maintains for storing the Transaction Identifiers created for each advertiser.

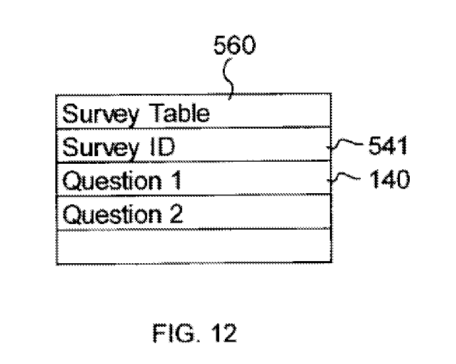

Now referring to FIG. 12 we show the fields of information that TRUSTED THIRD PARTY maintains storing a plurality of surveys.

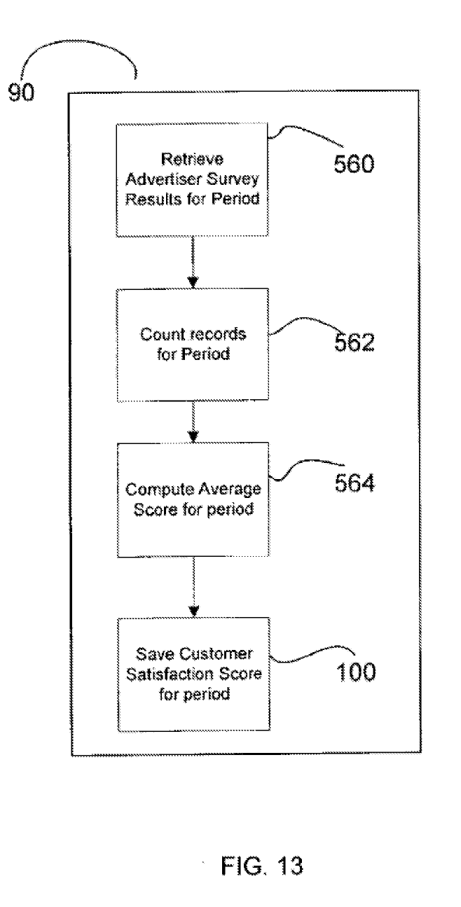

Now referring to FIG. 13 we illustrate the process of computing Customer Satisfactions Scores for advertisers registered with TRUSTED THIRD PARTY. All survey results are retrieved from Consumer Satisfaction Survey Results Table (FIG. 10) for a given Advertiser for a specific period of time 560. The query results are counted for said period 562 and an average Customer Satisfaction Score is computed for said time 564. Results are stored in TRUSTED THIRD PARTY's Advertiser Table (FIG. 8) for said Advertiser for said period.

Operations—FIG. 1 A Seller of goods and services who wish to advertise their services to consumers' invention (Advertisers), register with TRUSTED THIRD PARTY 1. TRUSTED THIRD PARTY provides said advertiser 12 with Token Identifiers (TIs) that said Advertiser gives to each customer. Customers of said advertisers can use TI to access TRUSTED THIRD PARTY's service via the web or via phone, register and provide feedback on their level of satisfaction received after the delivery of goods and services purchased from said Advertiser. Consumer feedback is collected, stored, scored and presented using a plurality of advertising medias by TRUSTED THIRD PARTY.

Consumers seeking services can access TRUSTED THIRD PARTY's web site and view the customer satisfaction score of a plurality of service providers to help said consumer make an informed purchase decisions.

Accordingly the reader will see that our invention enables all service providers to advertise their goods and services based on the value of their service delivery versus the size of their advertising budget. Service providers using this invention will be rewarded for improving the quality of their service delivery as measure by their customer's level of satisfaction.

Consumers using this invention will now have a way to make educated and objective decisions when purchasing the services of service providers.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for capturing, storing, processing and displaying customer satisfaction information in offline transactions comprising the steps of;
registering an advertiser to advertise with a trusted third party;
storing registration data of said business in a database;
generating a series of unique transaction identifiers for the advertiser from said database;
recording a digital record of the transaction identifiers generated for said advertiser and storing them in a transaction identifiers table within the database;
providing physical transaction identifiers to said advertiser;
forward one transaction identifiers to a customer by said advertiser at the time said customer purchases services or merchandise from said advertiser.

2. The method for capturing, storing, processing and displaying customer satisfaction information in offline transactions of claim 1 further comprising the steps of:
accessing the database from any electronic device that has access to the Internet with browser by a customer of an advertiser;
authenticating said customer in said database;
requesting a consumer satisfaction survey by entering the advertisers phone number and the transaction identifier code printed on the transaction identifiers in a said customer's possession;
validating eligibility of a consumer's requests and returning a specific online survey as a defined advertiser table;
answering questions by selecting a single answer from a range of possible responses for each question;
storing results of the completed survey in a results table; and
updating a consumer satisfaction score for said advertiser in the database.

3. The method for capturing, storing, processing and displaying customer satisfaction information in offline transactions of claim 2 wherein the trusted third party makes an advertiser's scores available for presentation in the following advertising media; trusted third party Web Site, Advertisers Web Site, Display Advertisements, Telephone, Television, Wireless Devices, and Promotional Items.

4. The method for capturing, storing, processing and displaying customer satisfaction information in offline transactions of claim 3 wherein
upon entering the trusted third party website new consumers can register with the trusted third party;
after registration, the trusted third party will validate consumer data to assure that the consumer is real and their entry is unique;
registered consumers can log onto the trusted third party website;
consumers can retrieve a survey if they have a digital transaction identifier in their account or they can retrieve a survey manually by retrieving the advertiser and entering the transaction identifier code.

5. The method for capturing, storing, processing and displaying customer satisfaction information in offline transactions of claim 4 wherein
an integrity check is complete to insure that a valid request is being made;
the transaction identifier code is entered by consumers are matched against transaction identifier codes in the issued transaction identifier table;
a check is made for a record with a matching advertiser ID, a matching Transaction Identifier code, and a null entry in the Customer ID;
if no match is found the customer will be presented with an error message;
a second test is completed to see if said consumer has completed a survey for the advertiser by searching a customer satisfaction survey results table;
a search will look for a record where a match exists for Customer ID and Advertiser;
if a matching record exist a final test compare the time since the last survey was completed and the minimum time specified in the Advertiser Table Survey Frequency;
if sufficient time hasn't past since the last survey was complete the customer will be presented with an ineligible message and the transaction identifier will be marked as ineligible;
eligible surveys are retrieved and completed by customer;
the survey results are stored in trusted third party 's database;
a new Customer Satisfaction score for this Advertiser is computed;
said consumer is awarded points for completing said survey; and
the results of the survey are emailed to said consumer.

6. The method for capturing, storing, processing and displaying customer satisfaction information in offline transactions of claim 5 further comprising the steps of creating unique Transaction Identifiers for registered Advertisers and distributing transaction identifier's to advertiser's customers:
registered advertisers request transaction identifier's from the trusted third party;
the trusted third party creates unique transaction identifier codes and stores transaction identifier codes in and Issued Transaction ID Table;
physical transaction identifier's are printed by the trusted third party and delivered to said advertiser;
the advertiser gives a consumer portion of one transaction identifier to each customer at the time of purchase; and
said registered advertisers print transaction identifiers from a printable file that is created by the trusted third party.

7. The method for capturing, storing, processing and displaying customer satisfaction information in offline transactions of claim 5 further comprising the step of creating a digital transaction identifier when a consumer uses a credit card or debit card to buy goods and service from advertiser:
a consumer pays for purchases with a credit card or debit card of a participating credit card issuer;
the transaction is authorized by credit card issuer and a unique transaction code is created and issued by the credit card issuer;
the credit card issuer transmits transaction data consisting of Advertiser identification, customer identification and transaction code to the trusted third party;
the trusted third party saves the credit card issuer transaction data to an Issued Transaction Identifier using the credit card issuer transaction code as the transaction identifier; and
the Consumer is given a credit card issuer authorized purchase receipt with the credit card issuer transaction code.

8. The method for capturing, storing, processing and displaying customer satisfaction information in offline transactions of claim 5 further comprising the step of displaying the mark of the trusted third party, the advertisers customer satisfaction score, and means of identifying the advertising on a plurality of advertising media.

9. The method for capturing, storing, processing and displaying customer satisfaction information in offline transactions of claim 5 a website of the trusted third party presents a registered advertiser's customer satisfaction history and score and additional identifying information.

10. The method for capturing, storing, processing and displaying customer satisfaction information in offline transactions of claim 5 wherein the additional identifying information includes the Advertisers Name, date of said Advertisers original membership, the number of Customer Satisfaction Surveys completed to date, the question or questions asked on survey, the number of surveys and their average score for the last year, and the last six months and the last three months scores.

12. The method for capturing, storing, processing and displaying customer satisfaction information in offline transactions of claim 5 wherein each transaction identifier consists of two parts, an Advertisers section and a customer's section.

13. The method for capturing, storing, processing and displaying customer satisfaction information in offline transactions of claim 5 wherein
the transaction identifier is printed on a plurality of substrates;
the consumer's portion is detached from the Advertisers section by tearing at a perforation;
the key data on the transaction identifier's are a serial number, said advertisers name, said Advertiser address, said Advertisers phone number, trusted third party's web site URL, trusted third party's phone number, trusted third party's logo, and transaction identifier code which consist of a randomly generated alpha numeric code;
said Advertiser's section contains sections for collecting consumer information, order number, and date of transactions.

14. The method for capturing, storing, processing and displaying customer satisfaction information in offline transactions of claim 5 wherein
the trusted third party maintains a plurality of surveys that are served to consumers based upon the contents of the Survey ID field;
the data on each survey contains Advertisers name, Advertisers address, Advertisers phone number, Transaction Identifier Code;
a means for displaying a plurality of questions;
a means for collecting consumer responses; and
said customers weighting of the importance of each question being asked.

15. The method for capturing, storing, processing and displaying customer satisfaction information in offline transactions of claim 5 wherein
the advertiser records information that links and identifies each customer to a used transaction identifier, and
the trusted third party audits the advertiser to insure legitimate transactions have taken place.

16. The method for capturing, storing, processing and displaying customer satisfaction information in offline transactions of claim 14 wherein the survey is presented to the customer via a web page.

17. The method for capturing, storing, processing and displaying customer satisfaction information in offline transactions of claim 14 wherein the survey is presented to the customer via the telephone.

18. The method for capturing, storing, processing and displaying customer satisfaction information in offline transactions of claim 5 where
all survey results are retrieved from a Consumer Satisfaction Survey Results Table for a given Advertiser for a specific period of time;
the query results are counted for said period and an average Customer Satisfaction Score is computed for said time; and
results are stored in the trusted third party's Advertiser Table for said Advertiser for said period.
